(19) United States
(12) Patent Application Publication
(10) Pub. No.: US 2026/0321285 A1
(43) Pub. Date: Oct. 15, 2026

(54) DATA STORAGE DEVICE THAT INCLUDES A PLASTIC COMPONENT HAVING ELECTRICALLY-CONDUCTIVE NANOFILLER, AND RELATED ARTICLES, SYSTEMS, AND METHODS

(71) Applicant: Seagate Technology LLC, Fremont, CA (US)

(72) Inventors: Michael Yi Zhao YAO, Singapore (SG); Chee Yin CHAN, Singapore (SG); YiLing LV, Wuxi (CN)

(21) Appl. No.: 19/178,652

(22) Filed: Apr. 14, 2025

(51) Int. Cl. G11B 5/49; G11B 5/82; G11B 33/14

(52) U.S. Cl. CPC G11B 5/49; G11B 5/82; G11B 33/1493

(57) ABSTRACT

A molded, plastic component configured to be disposed within a housing of a data storage device. The plastic, molded component includes a polymeric matrix, and one or more electrically-conductive nanofillers dispersed within the polymeric matrix. Data storage devices that include one or more of the molded, plastic components, and methods of making the molded, plastic components.

### BACKGROUND

The present disclosure relates to managing static electricity of plastic components disposed in data storage devices like hard disk drives (HDDs). There is a continuing need for improvements related to managing static electricity of plastic components disposed within data storage devices.

### SUMMARY

The present disclosure includes embodiments of a molded, plastic component configured to be disposed within a housing of a data storage device. The plastic, molded component includes a polymeric matrix; and one or more electrically-conductive nanofillers dispersed within the polymeric matrix.

The present disclosure also includes embodiments of a method of making a molded, plastic component configured to be disposed within a housing of a data storage device. The method includes molding a composition into a molded, plastic component. The composition includes at least one plastic resin and one or more electrically-conductive nanofillers dispersed within the at least one plastic resin. The molded, plastic component is configured to be disposed within a housing of a data storage device.

### BRIEF DESCRIPTION OF THE DRAWINGS

The discussion below makes reference to the following figures, wherein the same reference number may be used to identify the similar/same component in multiple figures. The schematic figures are for illustration purposes and are not necessarily drawn to scale.

FIG. 1A is an exploded, perspective view of an example of a hard disk drive that may include one or more adsorbent compositions according to the present disclosure;

FIG. 1B is a perspective view of the hard disk drive shown in FIG. 1A in its assembled configuration and showing interior components in broken lines;

FIG. 2A is a perspective view of an environmental control module (ECM) as an example of a molded, plastic component according to the present disclosure;

FIG. 2B is an exploded, perspective view of an environmental control module (ECM) shown in FIG. 2A; and

FIG. 3 is a partial, perspective view of the hard disk drive in FIG. 1A illustrating a head-stack assembly bobbin and a head-stack assembly bracket as examples of a molded, plastic component according to the present disclosure.

### DETAILED DESCRIPTION

Plastic components (e.g., molded components such as an ECM housing or an HSA bracket) present in an interior volume of a data storage device such as hard disk drive (HDD) tend to be statically insulative, which can cause them to attract particles, e.g., during manufacturing and/or assembly. This can cause undue contamination at the head/disk interface during the life of an HDD. Carbon fiber has been used to dissipate surface charge and avoid undue particle attraction to the plastic surface and to enhance the mechanical strength of the plastic components. Carbon fibers (also referred to as CF or graphite fiber) are fibers having a diameter from about 5 to 10 micrometers (0.00020-0.00039 in) and are composed mostly of carbon atoms. Unfortunately, a relatively high particle loading of carbon fiber (e.g., 10-30%) in a molded, plastic component is used to provide sufficient static discharge. Such a high loading of carbon fiber can itself cause particle contamination in an HDD. For example, such a high loading of carbon fiber can increase one or more of the liquid particle count (LPC), hard particle count, or stainless steel level within the molded, plastic component to an undue degree, which is undesirable. If desired, carbon fiber cannot be included in a molded, plastic component so as to avoid the particle contamination issues. But then the molded, plastic component tends to be statically insulative, as mentioned above, which can cause particles to be attracted to the surface of the molded, plastic component to an undue degree.

According to the present disclosure, as discussed in detail further below, electrically-conductive nanofiller can provide sufficient static discharge at much lower loadings (e.g., 05-5%), which can avoid undue particle contamination in an HDD.

According to one aspect of the present disclosure, a molded, plastic component configured to be disposed within a housing of a data storage device includes a polymeric matrix, and one or more electrically-conductive nanofillers dispersed within the polymeric matrix.

A polymeric matrix includes at least one plastic resin. The plastic resin constitutes a major portion of the polymeric matrix that forms the molded, plastic component. A plastic resin can be selected based on one or more factors such as processability in manufacturing equipment (e.g., extrusion molder), compatibility with the interior gas space of a data storage device, functionality of the molded, plastic component within the data storage device, compatibility with other additives (e.g., electrically-conductive nanofillers), combinations of these, and the like. A wide variety of plastic resins can be used to make a molded, plastic component. Non-limiting examples a plastic resin include polycarbonate (PC), polyoxymethylene (POM), polyamide (nylon), polyethylene terephthalate (PET), polybutylene terephthalate (PBT), polyether ether ketone (PEEK), polyetherimide(PEI), and combinations thereof.

As mentioned, the plastic resin constitutes a major portion of the polymeric matrix that forms the molded, plastic component. In some embodiments, the plastic resin is present in an amount of at least 80 percent, at least 85 percent, at least 90 percent, at least 95 percent, or even at least 97 percent by total weight of the plastic, molded component.

According to the present disclosure, the polymeric matrix includes one or more electrically-conductive nanofillers dispersed within the polymeric matrix. As mentioned above, an electrically-conductive nanofiller can be selected to provide sufficient static discharge (“surface resistivity” when incorporated into a molded, plastic component) at a loading that can advantageously avoid undue particle contamination in a data storage device such as an HDD. For example, managing the surface resistivity of a molded, plastic component can avoid undue particle attraction during manufacturing and/or assembly of the molded, plastic component, which can avoid undue contamination at the head/disk interface during the life of an HDD. Also, with respect to hard disk drives, managing the loading of a nanofiller in a molded, plastic component can avoid undue particle contamination by the nanofiller in an HDD. In some embodiments, including an electrically-conductive nanofillers in a molded, plastic component according to the present disclosure can provide desirable “surface resistivity” while maintaining one or more of the liquid particle count (LPC), hard particle count, or stainless steel level within specification. For example, an ECM body was formulated with polycarbonate and carbon nanotube in an amount of 3% by weight of the ECM body, and another ECM body was formulated with polycarbonate without carbon fiber or carbon nanotube. The ECM with carbon nanotube had a surface resistivity from about 1*10\hat{ }⁶ (ohms per square) to about 9.9*10\hat{ }¹⁰ (ohms per square) as measured by ASTM D257, and an LPC of about 14,000 (>0.3 micrometer particles per square centimeter), which is below a specification of 34,000 (>0.3 micrometer particles per square centimeter). The ECM body without carbon fiber or carbon nanotube had a surface resistivity greater than 1*10\hat{ }¹¹ (ohms per square) as measured by ASTM D257, and an LPC of about 15,000 to 20,000 (>0.3 micrometer particles per square centimeter). It has been determined that a reduced level of liquid particle count (LPC) correlates to a lower level of hard particle count and stainless steel level. As can be seen, using carbon nanotube at a loading of 3% produced an LPC about the same, or even less than using than using no carbon nanotube or carbon fiber. Thus, using electrically-conductive nanofillers are considered relatively cleaner as compared to carbon fiber.

An electrically-conductive nanofiller can also be selected based on one or more additional factors such as processability in manufacturing equipment (e.g., extrusion molder), compatibility with the interior gas space of a data storage device, functionality of the molded, plastic component within the data storage device, compatibility with the resin of the plastic component, compatibility with any other additives that may be present, combinations of these, and the like.

As used herein, “electrically-conductive nanofiller” refers to the physical structure of a nanofiller having at least one dimension of 300 nanometers or less, 150 nanometers or less, or even 100 nanometers or less. Electrically-conductive nanofillers can include one-dimensional nanofillers, two-dimensional nanofillers, three-dimensional nanofillers, and combinations thereof. One-Dimensional (1D) Nanofillers are typically rod-like or fiber-like structures with one dimension in the nanoscale, and nonlimiting examples of one-dimensional electrically-conductive nanofiller include carbon nanotubes, carbon nanofibers, and combinations thereof. Two-Dimensional (2D) Nanofillers are sheet-like structures with two dimensions in the nanoscale and nonlimiting examples of two-dimensional electrically-conductive nanofillers include graphene, nanoclays, MXenes, and combinations thereof. Three-Dimensional (3D) Nanofillers are typically spherical or cube-like structures with all three dimensions in the nanoscale and nonlimiting examples of three-dimensional electrically-conductive nanofillers include nanoparticles, nanobeads, and combinations thereof. Electrically-conductive nanofillers can be solid or hollow structures.

In some embodiments, an electrically-conductive nanofiller can include at least one carbon, electrically-conductive nanofiller. In some embodiments, a carbon, electrically-conductive nanofiller has an electrical conductivity from 1*10\hat{ }² (siemens per meter) to 1*10\hat{ }⁷ (siemens per meter), or even from 1*10\hat{ }³ (siemens per meter) to 1*10\hat{ }⁶ (siemens per meter).

In some embodiments, one or more carbon, electrically-conductive nanofillers can be chosen from carbon nanotubes, graphene, carbon nanofibers, and combinations thereof. Such carbon, electrically-conductive nanofillers can advantageously have one or more of 1) a small diameter that permits it to be dispersed well in the polymeric matrix in a low amount, 2) relatively high conductivity, or 3) is relatively clean in terms of, e.g., LPC.

Carbon nanotubes (CNTs) are an allotrope of carbon and are composed of sp²-bonded carbon atoms arranged in a hexagonal lattice. CNTs are cylindrical nanostructures with diameters in the nanometer range. CNTS include single-walled carbon nanotubes (SWCNTs) or multi-walled carbon nanotubes (MWCNTs). In some embodiments, SWCNTs have a diameter in a range from 0.4 to 3 nanometers, or even from 0.5 to 2 nanometers. SWCNTs can be formed by cutting sheets from two-dimensional sheets of graphene, and rolling the cut-outs into hollow cylinders (SWCNTs). In some embodiments, MWCNTs have a diameter in a range from 2 to 100 nanometers. MWCNTs. MWCNTs include nested single-walled (tube in tube) structures. In some embodiments, CNTs have a length from 50 nanometers to greater than one micrometer or even greater than one millimeter. In some embodiments, CNTs can have a relatively high aspect ratio (length-to-diameter) such as from 100 to 10,000. In some embodiments, CNTs have an electrical conductivity from 1*10\hat{ }³ (siemens per meter) to 1*10\hat{ }⁶ (siemens per meter).

Graphene is an allotrope of carbon, and is a two-dimensional (2D) sheet of sp²-hybridized carbon atoms arranged in a honeycomb lattice. Graphene is one atom thick (about 0.34 nanometers). The lateral size of graphene can depend on how it was synthesized. In some embodiments, graphene can have a lateral size from several nanometers to millimeters. In some embodiments, graphene has an electrical conductivity from 1*10\hat{ }⁶ (siemens per meter) to 1*10\hat{ }⁷ (siemens per meter).

Carbon nanofibers (CNFs) are an allotrope of carbon and are composed of graphene layers arranged as stacked cones, cups, or plates. In some embodiments, CNFs can have a diameter in a range from 50 to 300 nanometers. In some embodiments, CNFs have a length from a few micrometers to millimeters. In some embodiments, CNFs can have an aspect ratio (length-to-diameter) from 10 to 1000. In some embodiments, CNFs have an electrical conductivity from 1*10\hat{ }² (siemens per meter) to 1*10\hat{ }³ (siemens per meter).

In some embodiments, an electrically-conductive nanofiller can be combined with a plastic resin so that the corresponding plastic, molded component has a surface resistivity of less than 1*10\hat{ }¹¹ (ohms per square) as measured by ASTM D257, less than 1*10\hat{ }¹⁰ (ohms per square) as measured by ASTM D257, less than 1*10\hat{ }⁹ (ohms per square) as measured by ASTM D257, less than 1*10\hat{ }⁸ (ohms per square) as measured by ASTM D257, less than 1*10\hat{ }⁷ (ohms per square) as measured by ASTM D257, less than 1*10\hat{ }⁶ (ohms per square) as measured by ASTM D257, less than 1*10\hat{ }⁵ (ohms per square) as measured by ASTM D257, or even less than 1*10\hat{ }⁴ (ohms per square) as measured by ASTM D257.

In some embodiments, an electrically-conductive nanofiller is present in an amount of 5 percent or less, or even 4 percent or less, by total weight of the at least one plastic, molded component. In some embodiments, an electrically-conductive nanofiller is present in an amount from 0.5 to 5 percent, from 0.5 to 4 percent, or even from 1 to 4 percent by total weight of the at least one plastic, molded component.

Optionally, a polymeric matrix according to the present disclosure can include one or more additional components. A non-limiting example of an additional component includes clay minerals such as Kaolin, Montmorillonite, mica, and combinations thereof, to enhance mechanical properties including rigidity, and thermal stability.

A molded, plastic component configured to be disposed within a housing of a data storage device can be made by molding a composition into a molded, plastic component. The composition includes at least one plastic resin and one or more electrically-conductive nanofillers dispersed within the at least one plastic resin. The plastic resin and electrically-conductive nanofillers are discussed above, and not repeated here.

The plastic resin and electrically-conductive nanofillers can be combined in any desired manner so that the composition is relatively homogeneous and facilitates molding the composition into a molded, plastic component configured to be disposed within a housing of a data storage device having a desired shape, e.g., as illustrated above.

In some embodiments, plastic resin and electrically-conductive nanofillers can be combined by blending solid plastic resin and electrically-conductive nanofiller to form a mixture (compounded material) where the electrically-conductive nanofillers uniformly dispersed with the plastic resin. Non-limiting examples of blending include dry blending or melt compounding. In dry blending, the plastic resin and electrically-conductive nanofiller are physically mixed in a tumbler or high-intensity mixer before extrusion. In melt-compounding, plastic resin is melted and the electrically-conductive nanofiller can be introduced and dispersed within the molten polymer.

The mixture (compounded material) can then be extruded to form the composition, e.g., a plurality of pellets. For example, extrusion can occur in an extruder (e.g., twin-screw extruder), where the mixture is melted by heat and mechanical shear to form a molten blend that is forced through a die head into continuous strands that can be cooled and cut into pellets.

The pellets can then be fed to an injection molding machine to form a molded, plastic component as described herein. For example, pellets can be fed to an injection molding machine, which uses a mold to form molded, plastic components as described herein.

Molded, plastic components made according to the present disclosure can be positioned and/or mounted within a housing of data storage device while assembling the data storage device.

Non-limiting examples of a molded, plastic component include a head-stack assembly bobbin, a head-stack assembly bracket, an environmental control module, a diverter, spoiler, shroud, a latch in the voice coil magnet assembly (VCMA), disk separator plate (DSP), and combinations thereof.

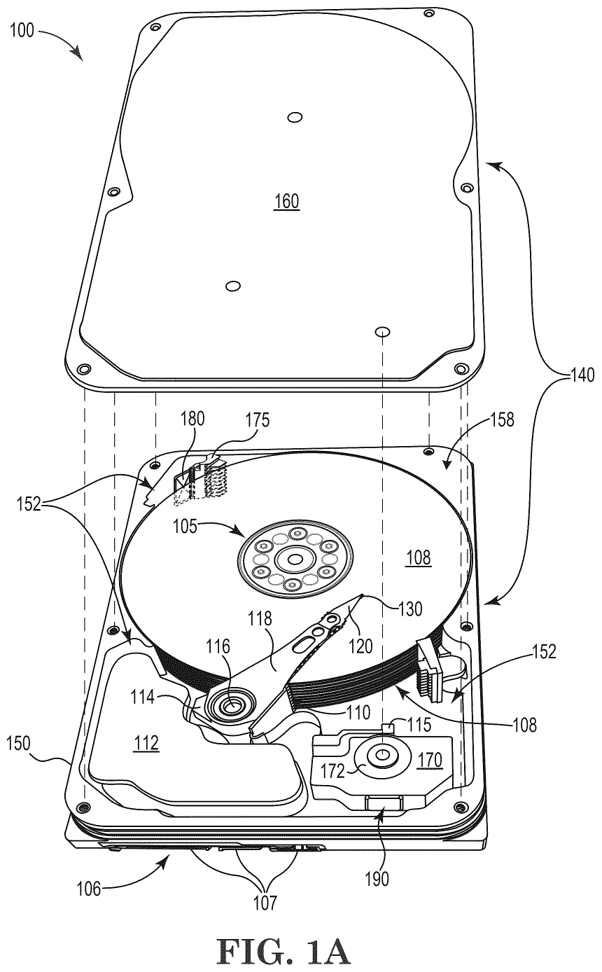

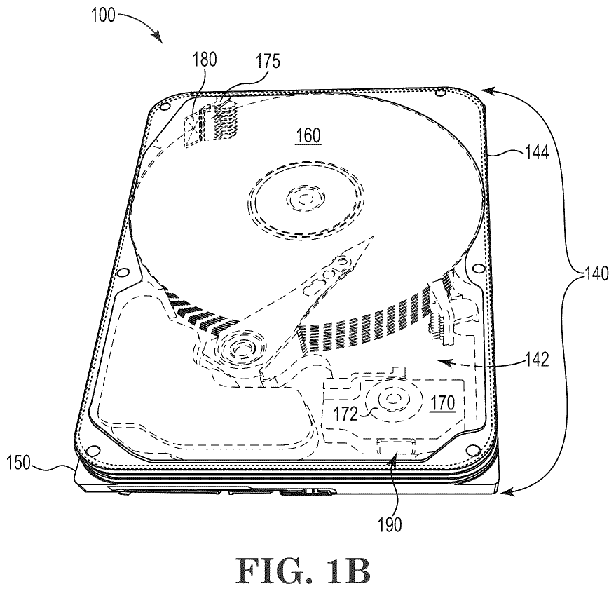

An example of a data storage device 100 that may include one or more molded, plastic components having electrically-conductive nanofillers will be described with respect to FIGS. 1A and 1B.

Data storage device 100 is illustrated as a hard-disk drive (HDD) that includes an outer enclosure or housing 140 configured to contain multiple hard-disk drive components, including electronic components. Housing 140 includes a base 150 and a top cover 160.

Base 150 includes a recess or cavity 152 configured to accommodate components of data storage device 100. Data storage device 100 further includes a printed circuit board assembly (PCBA) 106. PCBA 106 of this configuration is coupled to base 150 and includes a plurality of input/output connectors 107 that are each configured to provide an interface between one or more components of data storage device 100 and one or more host devices (e.g., a computer, a server, a consumer electronic device, or the like).

Base 150 and top cover 160 may be formed from any suitable material, such as metal (e.g., aluminum), plastic, or other suitable material, or combinations thereof. In some embodiments, base 150 includes multiple components, such as an outer frame and a bottom cover, that are coupled together (e.g., by screws, welding, or the like).

Top cover 160 is configured to couple to base 150 to enclose components of data storage device 100, as shown in FIG. 1B. As shown, top cover 160 is aligned with and coupled to a surface of base 150, such as a surface 158 shown in FIG. 1A, to define an interior volume 142 of data storage device 100, which includes an interior gas space.

Components other than those illustrated or specifically identified in FIGS. 1A and 1B and described herein are contemplated as being positioned within the interior volume 142, such as a preamp, a load/unload ramp, and/or assembly hardware, for example. Top cover 160 can be coupled to base 150 using any suitable technique, such as using one or more screws, connection fingers, locking/clipping structures, adhesives, rivets, other mechanical fasteners, welding (e.g., ultrasonic welding) or combinations thereof.

In some embodiments, data storage device 100 can further include one or more seals 144 disposed between base 150 and top cover 160 and configured to seal the interior volume 142 of data storage device 100. In embodiments, seal 144 can be a weld formed between base 150 and top cover 160, or seal 144 can be a form-in-place gasket (FIPG). Examples of a FIPG include epoxy (e.g., a two-part epoxy) and acrylate, among others.

The FIPG may be applied along an outer edge of top cover 160 and/or base 150 and thermally cured after coupling top cover 160 to base 150, for example. Other methods of sealing can additionally or alternatively be used to connect the base 150 to top cover 160.

A gas or gas mixture may be added to interior volume 142 of data storage device 100. Helium, for example, may be included in interior volume 142 to reduce mechanical vibrations, particularly of head gimbal assemblies (HGAs) of data storage device 100.

Helium may also be included within data storage device 100 to enable lower head-media spacing (HMS) between a reader and/or writer of a magnetic recording head and a magnetic disk, and thus a higher areal density capability (ADC) of data storage device 100.

In some embodiments, data storage device 100 can be a hermetically sealed data storage device, which can be defined by, e.g., the amount of gas (e.g., helium) that leaks from the data storage device after it has been sealed (e.g., a welded HDD). In some embodiments, a hermetically sealed data storage device having its interior gas space filled with helium gas has a nominal helium leak rate of less than 10% by volume in five years. In some embodiments, in terms of (atm cc/second), a hermetically sealed data storage device having its interior gas space filled with helium gas has a nominal helium leak rate of 10×10\hat{ }−8 atm (atmosphere) cc (cubic centimeter)/second or less at 25 °C; 8×10\hat{ }−8 atm cc/second or less, 5×10\hat{ }−8 atm cc/second or less; or even 4×10\hat{ }−8 atm cc/second or less at 25 °C.

Data storage device 100 includes a head stack assembly (HSA) 110 and one or more magnetic disks 108 configured to store bits of data. HSA 110 further includes a head-stack assembly bracket 115 (discussed below), and a plurality of HGAs 120.

Each HGA 120 includes a magnetic recording head 130 with a read head and a write head for reading data from and writing data to a surface of a magnetic disk 108.

Other components of a magnetic recording head 130 can be included, such as heaters, heat sinks, and piezoelectric actuators, for example. For a heat-assisted magnetic recording (HAMR) HDD, a magnetic recording head 130 may include a light source such as a laser, a waveguide, and a near-field transducer (NFT) to heat and lower the coercivity of magnetic grains in a spot of focus on a magnetic disk 108.

Data storage device 100 further includes a motor assembly 105 configured to rotatably support magnetic disks 108 and circumferentially rotate magnetic disks 108 about an axis of rotation during operation. Magnetic disks 108 are mounted on motor assembly 105 such that an annular volume of each magnetic disk 108 encircles a portion of motor assembly 105. Motor assembly 105 may rotate magnetic disks 108 during an operation of data storage device 100 such that each magnetic disk 108 moves relative to a respective magnetic recording head 130 to enable the magnetic recording heads 130 to read data from and/or write data to the magnetic disk 108.

Data storage device 100 also includes a voice coil drive actuator 112 that produces a magnetic field that exerts a force on an actuator mechanism 114, causing actuator mechanism 114 to rotate about a shaft 116 in either rotational direction. Rotatable drive actuator arms 118 are mechanically coupled to actuator mechanism 114 and to each HGA 120 such that rotating actuator mechanism 114 causes rotatable drive actuator arms 118 and HGAs 120, and thus magnetic recording heads 130, to move relative to magnetic disks 108.

Data storage device 100 includes a diverter 175 that is proximal to magnetic disks 108. Diverter 175 is configured to divert helium and/or other interior gas mixtures(s) to reduce windage on rotatable drive actuator arms 118 which can reduce undesired vibrations that may cause a magnetic recording head 130 to move off track and/or contact a magnetic disk 108. As shown in FIG. 1A, data storage device 100 utilizes voice coil drive actuator 112 to move HGAs 120 relative to magnetic disks 108; however, it is understood that other means of moving HGAs 120, such as a voice coil motor (VCM), are contemplated.

Data storage device 100 includes components having an adsorbent composition in the form an article that permits the components to be positioned and/or mounted in the interior volume 142 of data storage device 100 so that the adsorbent composition can adsorb moisture and/or organic vapors from the interior gas. In some embodiments, a component can also include filtering capability to remove organic particulate material. As shown in FIGS. 1A and 1B, non-limiting examples of such components include an environmental control module 170, a recirculation filter 180, and a label filter 190 for such a purpose.

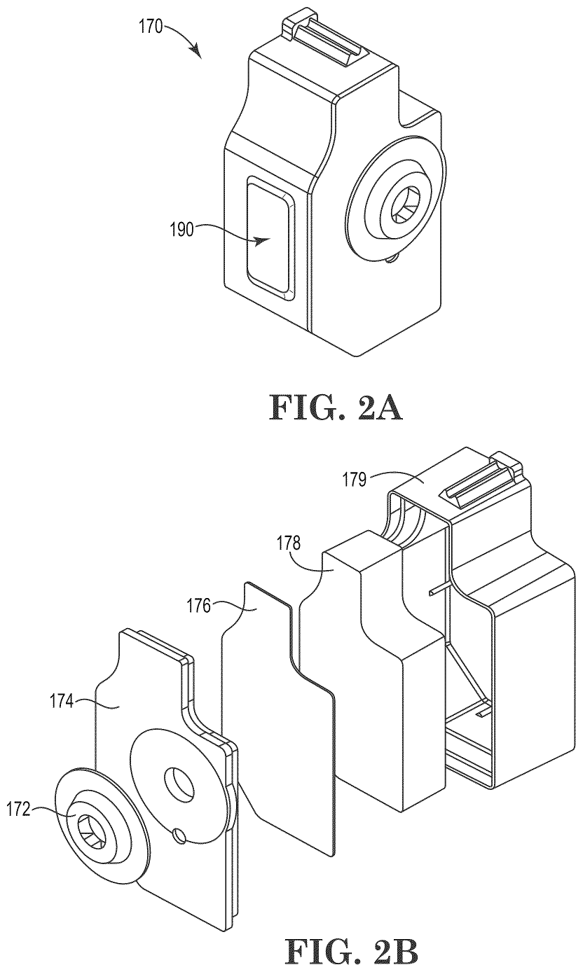

Environmental control module 170 is a non-limiting example of a molded, plastic component having an electrically-conductive nanofiller according to the present disclosure. A non-limiting example of environmental control module 170 is described in more detail with respect to FIGS. 2A and 2B. As shown in FIG. 2B, environmental control module 170 includes an article 178 in the form of an environmental control module tablet that is an adsorbent composition according to the present disclosure (discussed below). As shown in FIG. 2B, environmental control module tablet is configured to have a shape that conforms to the interior shape of body 179 of environmental control module 170. Body 179 is a part of the environmental control module 170 that is a non-limiting example of a molded, plastic component having an electrically-conductive nanofiller according to the present disclosure. As shown, environmental control module 170 also includes a lid 174 that forms a gas-tight enclosure when lid 174 is mounted to body 179. As shown, lid 174 has an inlet diffuser seal 172 that seals to top cover 160, for example. The inlet diffuser seal 172 helps keep the article 178 dry during manufacturing. Lid 174 is another part of the environmental control module 170 that is a non-limiting example of a molded, plastic component having an electrically-conductive nanofiller according to the present disclosure.

The environmental control module tablet can become exposed to the interior volume 142 of data storage device 100 by breaking the seal located at the bottom center of inlet diffuser seal 172 to create an opening (not shown) so that gas exchange can occur between the inside of environmental control module 170 and the interior volume 142. For example, as indicated by a dashed line in FIG. 1A, top cover 160 includes a through hole that lines up with the center of inlet diffuser seal 172. A pin can be inserted in the through hole and penetrate the seal located at the bottom center of inlet diffuser seal 172. Gas can be introduced via the through hole to fill the interior volume 142 and interior space of environmental control module with gas (e.g., helium or helium and oxygen). The through hole can be sealed after filling with gas. In some embodiments, inlet diffuser seal 172 can be made with a relatively soft material such as aluminum. Environmental control module 170 may include a filter 176 (e.g., a polytetrafluoroethylene (PTFE) membrane) that is configured to prevent particle contamination in gas that is exchange with interior volume 142, but allows gas to be exchanged between interior volume 142 and the space that includes article 178 so that the gas can contact article 178. Gas can be exchanged between interior volume 142 and the space that includes article 178 via sponge foam indicated by the raised donut section of inlet diffuser seal 172. The volume of environmental control module tablet tends to be relatively large compared to other adsorbent compositions within data storage device 100.

Recirculation filter 180 is configured to remove contaminants from a moving and relatively high flow of gas within interior volume 142 of data storage device 100. The moving flow of gas may include oxygen, air, helium, and/or other gases that are disposed in interior volume 142 of data storage device 100. The gas movement can be caused by proximity to rotating magnetic disks 108 during operation of data storage device 100, for example. As shown in data storage device 100, recirculation filter 180 is coupled to and supported by diverter 175.

As shown in FIGS. 1A, 1B, and 2A, label filter 190 is located on a side of environmental control module 170. In some embodiments, label filter 190 can be mounted to environmental control module 170 using an adhesive.

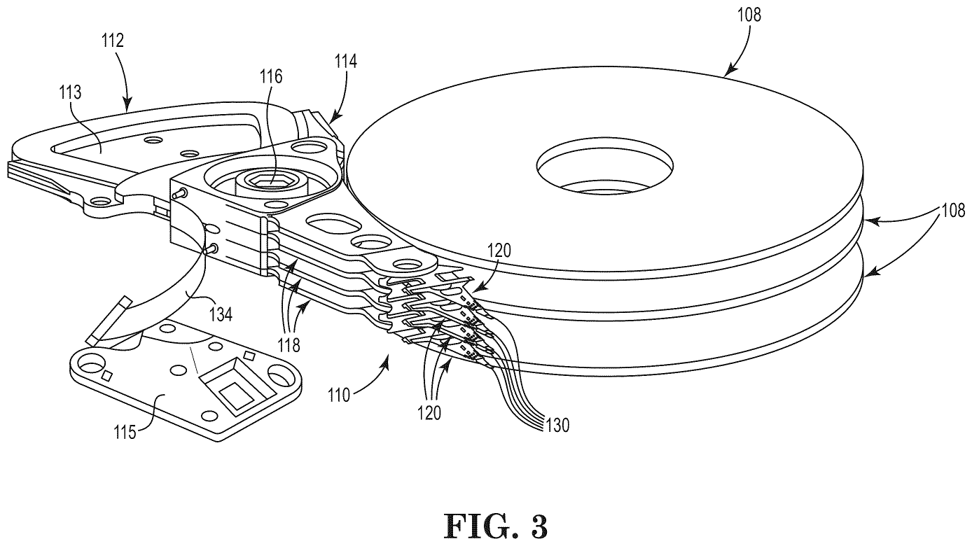

FIG. 3 is a perspective view of the data storage device 100 in FIG. 1A illustrating head stack assembly (HSA) 110 with additional detail. The head circuitry 134 is attached to head-stack assembly bracket 115 that is mounted within the data storage device 100 as shown in FIG. 1A.

HAS 110 includes a head-stack assembly bobbin 113, which a lightweight, plastic structure that serves as a mounting frame for the voice coil in the voice coil drive actuator 112. The voice coil, wound around the head-stack assembly bobbin 113, interacts with permanent magnets in the voice coil drive actuator 112 to generate motion.

Head-stack assembly bracket 115 and head-stack assembly bobbin 113 are non-limiting examples of a molded, plastic component having an electrically-conductive nanofiller according to the present disclosure.

1. A molded, plastic component configured to be disposed within an interior of a housing of a data storage device, wherein the plastic, molded component is a non-housing component and comprises:
a polymeric matrix; and
one or more electrically-conductive nanofillers dispersed within the polymeric matrix.

2. The molded, plastic component of claim 1, wherein the one or more electrically-conductive nanofillers comprise at least one carbon, electrically-conductive nanofiller having a diameter of 300 nanometers or less.

3. The molded, plastic component of claim 1, wherein the one or more electrically-conductive nanofillers comprise at least one electrically-conductive nanofillers chosen from carbon nanotubes, graphene, carbon nanofibers, and combinations thereof.

4. The molded, plastic component of claim 1, wherein the one or more electrically-conductive nanofillers are present in an amount of 5 percent or less by total weight of the plastic, molded component.

5. The molded, plastic component of claim 1, wherein the one or more electrically-conductive nanofillers are present in an amount from 0.5 to 5 percent by total weight of the plastic, molded component.

6. The molded, plastic component of claim 1, wherein the molded, plastic component has a surface resistivity of less than 1*10\hat{ }¹¹ (ohms per square) as measured by ASTM D257.

7. The molded, plastic component of claim 1, wherein the molded, plastic component has a surface resistivity of less than 1*10\hat{ }¹⁰ (ohms per square) as measured by ASTM D257.

8. The molded, plastic component of claim 1, wherein the polymeric matrix comprises at least one plastic resin chosen from polycarbonate (PC), polyoxymethylene (POM), polyamide (nylon), polyethylene terephthalate (PET), polybutylene terephthalate (PBT), polyether ether ketone (PEEK), polyetherimide(PEI), and combinations thereof.

9. The molded, plastic component of claim 1, wherein the molded, plastic component is chosen from a head-stack assembly bobbin, a head-stack assembly bracket, an environmental control module, and combinations thereof.

10. A data storage device comprising:
a housing having an interior gas space; and
at least one molded, plastic component of claim 1, wherein the at least one molded, plastic component is disposed within the interior of the housing.

11. The data storage device of claim 10, wherein the at least one molded, plastic component is chosen from a head-stack assembly bobbin, a head-stack assembly bracket, an environmental control module, a diverter, spoiler, shroud, a latch in the voice coil magnet assembly (VCMA), Disk separator plate (DSP), and combinations thereof.

12. A method of assembling at least a portion of a data storage device, wherein the method comprises positioning the molded, plastic component of claim 1 within a housing of the data storage device.

13. A method of making a molded, plastic component configured to be disposed within an interior of a housing of a data storage device, wherein the method comprises molding a composition into a molded, plastic component, wherein the composition comprises at least one plastic resin and one or more electrically-conductive nanofillers dispersed within the at least one plastic resin, and wherein the molded, plastic component is a non-housing component and configured to be disposed within an interior of a housing of a data storage device.

14. The method of claim 13, further comprising:
blending a solid plastic resin and an electrically-conductive nanofiller to form a mixture;
extruding the mixture to form the composition, wherein the composition comprises a plurality of pellets; and
injection molding the plurality of pellets to form the molded, plastic component.

15. The method of claim 14, wherein the one or more electrically-conductive nanofillers comprise at least one electrically-conductive nanofillers chosen from carbon nanotubes, graphene, carbon nanofibers, and combinations thereof.

16. The method of claim 14, wherein the one or more electrically-conductive nanofillers are present in an amount of 5 percent or less by total weight of the at least one plastic, molded component.

17. The method of claim 14, wherein the at least one plastic, molded component has a surface resistivity of less than 1*10\hat{ }¹² (ohms per square) as measured by ASTM D257.

18. The method of claim 14, wherein the at least one plastic, molded component has a surface resistivity of less than 1*10\hat{ }¹¹ (ohms per square) as measured by ASTM D257.

19. The method of claim 14, wherein the at least one plastic resin chosen from polycarbonate (PC), polyoxymethylene (POM), polyamide (nylon), polyethylene terephthalate (PET), polybutylene terephthalate (PBT), polyether ether ketone (PEEK), polyetherimide(PEI), and combinations thereof.

20. The method of claim 14, wherein the at least one molded, plastic component is chosen from a head-stack assembly bobbin, a head-stack assembly bracket, an environmental control module, and combinations thereof.
